(19) United States
(12) Patent Application Publication
(10) Pub. No.: US 2017/0217002 A1
(43) Pub. Date: Aug. 3, 2017

(54) TOOL FOR INSTALLING A ROLLER TAPPET IN AN INTERNAL COMBUSTION ENGINE AND RELATIVE METHOD

(71) Applicant: GM GLOBAL TECHNOLOGY OPERATIONS LLC, Detroit, MI (US)

(72) Inventors: Andrea PALMA, Giaveno (TO) (IT); Antonino CONTI, Torino (IT)

(73) Assignee: GM GLOBAL TECHNOLOGY OPERATIONS LLC, Detroit, MI (US)

(21) Appl. No.: 15/418,869

(22) Filed: Jan. 30, 2017

(30) Foreign Application Priority Data
Jan. 29, 2016 (GB) 1601818.6

(51) Int. Cl. B25B 27/00

(52) U.S. Cl. CPC B25B 27/0035; F02M 59/102

(57) ABSTRACT

A tool is disclosed for installing a roller tappet in a bore of the cylinder head of an internal combustion engine. The tool includes an elongated body and a connection head arranged at one end of the elongated body and configured to be at least in part inserted into an opening of the roller tappet. The tool further includes at least one reversible constraining element of the connection head to the roller tappet.

### CROSS-REFERENCE TO RELATED APPLICATION

This application claims priority to Great Britain Patent Application No. 1601818.6, filed Jan. 29, 2016, which is incorporated herein by reference in its entirety.

### TECHNICAL FIELD

The present disclosure pertains to the installation of a roller tappet in the cylinder head of an internal combustion engine.

### BACKGROUND

Roller tappets are used in internal combustion engine to operatively connect a cam of a rotatable shaft (e.g. the camshaft) of the internal combustion engine with a fuel unit pump, to actuate the latter. Accordingly, roller tappets are housed inside a bore of the cylinder head and, typically, a roller tappet is placed in position manually by inserting it from an upper side of the cylinder head.

This operation can be particularly complex, especially because generally the upper side of the cylinder head is not a planar surface, e.g. it typically includes a plurality of non-planar surfaces. As a result, it can be complex to correctly align the roller tappet to the hole of the cylinder head. Moreover the roller tappet usually includes anti-rotation protrusions to be coupled with complementary anti-rotation seats obtained in the bore of the cylinder head, thus increasing the difficulties of a manual assembling of the roller tappet inside the bore of the cylinder head. As a result, this operation can be complex and time inefficient. In fact, the operator has to carefully insert the roller tappet inside the bore of the cylinder head with the correct position and angle in order not to cause galling and damages to the components.

Accordingly, there is a need in the art to overcome the aforesaid drawbacks, and to provide a method for installing a roller tappet in an internal combustion engine in an easy, rapid and accurate way.

### SUMMARY

In accordance with the present disclosure, a tool is provided for installing a roller tappet in a bore of the cylinder head of an internal combustion engine. The tool includes an elongated body and a connection head arranged at one end of the elongated body and configured to be at least in part inserted into an opening of the roller tappet. The tool further includes at least one reversible constraining element of the connection head to the roller tappet. The tool allows simple and precise aligning of the roller tappet with the bore of the cylinder head. Furthermore, the roller tappet can be handled in simple manner.

According to another embodiment of the present disclosure, the reversible constraining element is of the snap fit or interlocking type. As a result, the tool is particularly reliable, and also quick and easy to be used.

According to an embodiment of the present disclosure, the reversible constraining element is configured to prevent the relative sliding movement of the connection head and the roller tappet. According to an embodiment of the present disclosure, the reversible constraining element includes a protruding portion and in particular an annular protruding portion, to prevent the relative sliding movement of the connection head and the roller tappet. In this way, it is possible to easily and quickly couple the tool with the roller tappet to handle the latter by the first. Furthermore, a simple and quick decoupling between the two elements is achieved in order to obtain an accurate axial placement of the roller tappet inside the bore of the cylinder head.

According to a further embodiment of the present disclosure, the annular protruding portion of the reversible constraining element is an O-ring. This solution has proven to be particularly effective and economic.

According to an embodiment of the present disclosure, the tool includes at least one rotation-locking element to prevent the relative rotation movement of the connection head and the roller tappet. In this way, it is possible to achieve the desired angular position of the roller tappet inside the bore of the cylinder head in a simple and fast manner. In other words, it is possible to achieve the desired relative angular position between the roller tappet and the bore of the cylinder head.

According to an embodiment of the present disclosure, the rotation-locking element includes at least one protruding element extending from the connecting head. The protruding element is preferably arranged in an offset position with respect to a longitudinal axis of the elongated cylindrical body. As a result, the tool is reliable and easy to be used.

According to another embodiment of the present disclosure, the protruding element is at least partially inserted in a seat of the roller tappet. This solution allows both effective and economic configuration. In fact, the protruding element can be inserted in an already-existing hole of the roller tappet, without the need of additional manufacturing operations on the roller tappet.

According to an embodiment of the present disclosure, the connection head includes a reduced cross section with respect to the cross section of the elongated cylindrical body. In this way, the tool can be quickly and easily coupled with the roller tappet.

An embodiment of the present disclosure further provides for a roller tappet configured to cooperate with the tool herein disclosed/claimed. The roller tappet includes a roller tappet body carrying a roller. The roller tappet body is least partially hollow so as to define an opening at one end of the roller tappet body. In use, the connection head of the tool is at least partially inserted inside the roller tappet body through the opening.

According to an embodiment, the roller tappet is provided with an internal groove to be engaged by the reversible constraining element, an in particular a protruding portion, of the tool. Advantageously, the relative sliding movement between the tool and the roller tappet can be effectively prevented.

According to an embodiment, the roller tappet includes a seat intended to cooperate with the rotation-locking element of the tool, and in particular with a protruding element, e.g. a pin, of the tool. Advantageously, the rotation movement applied to the tool can be effectively transferred to the roller tappet.

An embodiment of the present disclosure further provides for a system including a tool herein disclosed and a roller tappet cooperating with the tool.

An embodiment of the present disclosure further provides for a method for installing a roller tappet in a bore of the cylinder head of an internal combustion engine with a tool according to one or more of the preceding embodiments. The bore extends between two substantially opposite sides of the cylinder head defining a first opening on one of the opposite sides and second opening on the other of the opposite sides. The tool is inserted in the bore along an inserting direction. The roller tappet is constrained to the tool by inserting the connection head in the opening of the roller tappet. The roller tappet is installed in the bore of the cylinder head by sliding the tool inside the bore along an installing direction. The roller tappet is decoupled from the tool. The use of a tool, to which the roller tappet is constrained, provides a simpler and effective installation.

According to an embodiment of the present disclosure, the connection head of the tool is inserted from one side of the cylinder head (i.e. from one of the opening of the bore) and translated along the inserting direction towards the other side of the cylinder head (i.e. towards the other opening of the bore) until the connection head extends (protrudes) outside the other opening of the bore. The roller tappet is constrained to the connection head protruding outside the opening opposite to the opening from which the toll is inserted in the bore.

This advantageously allows the tool to be inserted from a side (opening of the bore) that is more accessible to an operator or to an automatic installing machine to which the tool can be associated. Subsequently, the roller tappet can be constrained to the tool, already inserted in the bore, and thus using the movement of the tool inside the bore to insert the roller tappet therein from a side of the cylinder head (from an opening of the bore) that is less accessible than the other side (opening) from which the toll is inserted.

According to an embodiment of the present disclosure, the inserting direction is opposite with respect to the installing direction. In this way, it is possible to insert and remove the tool from the opening allowing the easiest handling of the tool itself Also, the above mentioned change of direction can promote detachment (decoupling) of tool from the roller tappet.

According to an embodiment of the present disclosure, inserting the tool is carried out from the first opening arranged at a lower side of the cylinder head facing the engine block, towards the second opening arranged at the opposite side of the cylinder head.

According to another embodiment of the present disclosure, the first opening is arranged at a lower side of the cylinder head facing the engine block. Usually, the surface of the lower side of the cylinder head is a planar surface (for example including a mounting flange for the fuel unit pump at the first opening), while the surface of the upper side of the cylinder head is a non-planar surface. Carrying out the insertion of the tool from the first opening towards the second opening has proven to be a particularly easy, fast and safe operation.

According to a further embodiment of the present disclosure, the tool is rotated to orientate the roller tappet when installing the roller tappet in the bore of the cylinder head. In this way, it is possible to modify in a simple and fast manner the radial orientation of the roller tappet inside the bore of the cylinder head.

According to an embodiment of the present disclosure, the tool is rotated to align an anti-rotation protrusion of the roller tappet with an anti-rotation seat of the bore. In this way, it is possible to achieve an accurate radial placement of the roller tappet inside the bore of the cylinder head.

According to an embodiment of the present disclosure, the roller tappet reaches a sliding stop when installing the roller tappet in the bore of the cylinder head. In this way, it is possible to achieve an accurate axial placement of the roller tappet inside the bore of the cylinder head and at the same to provide a separation force to the roller tappet and the tool intended to decouple these components.

### BRIEF DESCRIPTION OF THE DRAWINGS

The present disclosure will hereinafter be described in conjunction with the following drawing figures, wherein like numerals denote like elements.

FIG. 1 shows a possible embodiment of an automotive system including an internal combustion engine in which the fuel unit pump can be used;

FIG. 2 is a cross-section according to the plane A-A of an internal combustion engine belonging to the automotive system of FIG. 1;

FIG. 3 is a perspective view of a roller tappet to be installed in an internal combustion engine;

FIG. 4 is another perspective view of the roller tappet of FIG. 3;

FIG. 5 is a perspective view of a tool for installing a roller tappet in an internal combustion engine according to the present disclosure;

FIG. 6 is a perspective view of the tool and the roller tappet before the constraining of the roller tappet to the tool;

FIG. 7 is a perspective view of the tool and the roller tappet during a step of the installation procedure;

FIG. 8 is a cross-section showing the tool and the roller tappet during another step of the installation procedure;

FIG. 9 is another perspective view of the tool during the installation procedure; and

FIG. 10 is a flowchart reporting the steps of the installation procedure (method of installation) of the roller tappet by the tool according to an embodiment of the present disclosure.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

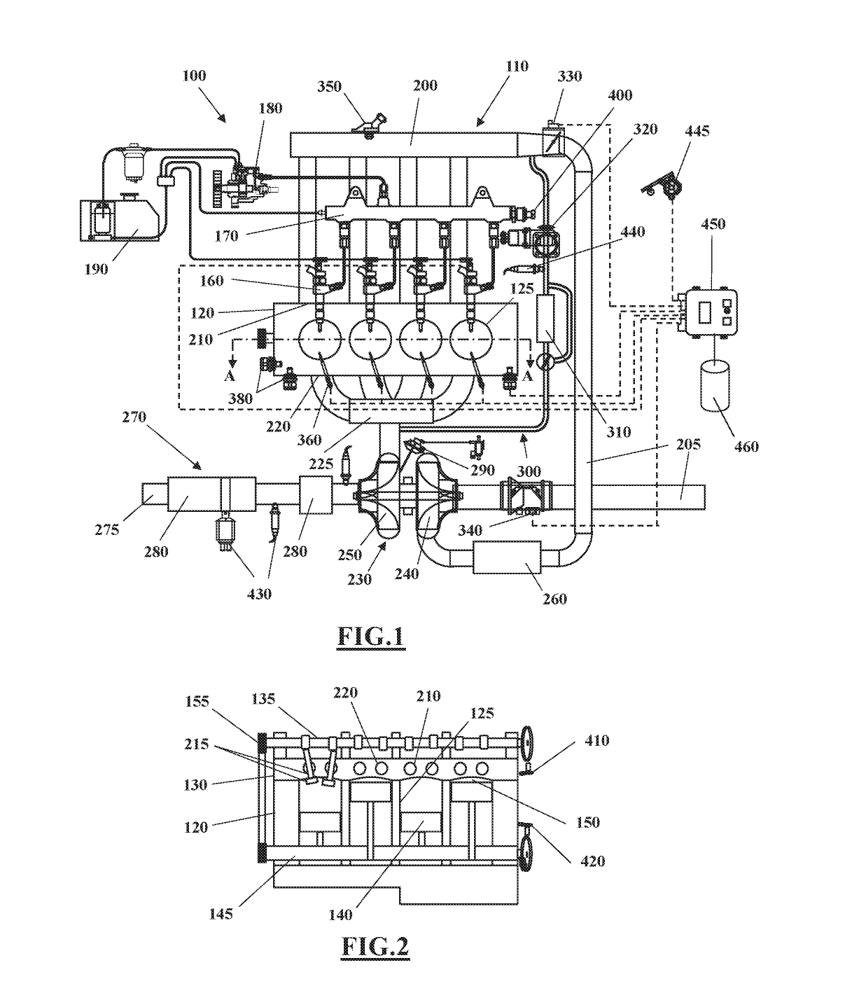

Some embodiments may include an automotive system 100, as shown in FIGS. 1 and 2, that includes an internal combustion engine (ICE) 110 having an engine block 120 defining at least one cylinder 125 having a piston 140 coupled to rotate a crankshaft 145. A cylinder head 130 cooperates with the piston 140 to define a combustion chamber 150. A fuel and air mixture (not shown) is disposed in the combustion chamber 150 and ignited, resulting in hot expanding exhaust gasses causing reciprocal movement of the piston 140.

The fuel is provided by at least one fuel injector 160 and the air through at least one intake port 210. The fuel is provided at high pressure to the fuel injector 160 from a fuel rail 170 in fluid communication with a high pressure fuel pump that increase the pressure of the fuel received from a fuel source 190. According to a possible embodiment, the engine includes a fuel unit pump 180 that is actuated by the rotation of a camshaft 135. Each of the cylinders 125 has at least two valves 215, actuated by the camshaft 135 rotating in time with the crankshaft 145. The valves 215 selectively allow air into the combustion chamber 150 from the port 210 and alternately allow exhaust gases to exit through a port 220. In some examples, a cam phaser 155 may selectively vary the timing between the camshaft 135 and the crankshaft 145.

The air may be distributed to the air intake port(s) 210 through an intake manifold 200. An air intake duct 205 may provide air from the ambient environment to the intake manifold 200. In other embodiments, a throttle body 330 may be provided to regulate the flow of air into the manifold 200. In still other embodiments, a forced air system such as a turbocharger 230, having a compressor 240 rotationally coupled to a turbine 250, may be provided. Rotation of the compressor 240 increases the pressure and temperature of the air in the duct 205 and manifold 200. An intercooler 260 disposed in the duct 205 may reduce the temperature of the air. The turbine 250 rotates by receiving exhaust gases from an exhaust manifold 225 that directs exhaust gases from the exhaust ports 220 and through a series of vanes prior to expansion through the turbine 250. The exhaust gases exit the turbine 250 and are directed into an exhaust system 270. This example shows a variable geometry turbine (VGT) with a VGT actuator 290 arranged to move the vanes to alter the flow of the exhaust gases through the turbine 250. In other embodiments, the turbocharger 230 may be fixed geometry and/or include a waste gate.

The exhaust system 270 may include an exhaust pipe 275 having one or more exhaust aftertreatment devices 280. The aftertreatment devices may be any device configured to change the composition of the exhaust gases. Some examples of aftertreatment devices 280 include, but are not limited to, catalytic converters (two and three way), oxidation catalysts, lean NOx traps, hydrocarbon adsorbers, selective catalytic reduction (SCR) systems, and particulate filters. Other embodiments may include an exhaust gas recirculation (EGR) system 300 coupled between the exhaust manifold 225 and the intake manifold 200. The EGR system 300 may include an EGR cooler 310 to reduce the temperature of the exhaust gases in the EGR system 300. An EGR valve 320 regulates a flow of exhaust gases in the EGR system 300.

The automotive system 100 may further include an electronic control unit (ECU) 450 in communication with one or more sensors and/or devices associated with the ICE 110. The ECU 450 may receive input signals from various sensors configured to generate the signals in proportion to various physical parameters associated with the ICE 110. The sensors include, but are not limited to, a mass airflow and temperature sensor 340, a manifold pressure and temperature sensor 350, a combustion pressure sensor 360, coolant and oil temperature and level sensors 380, a fuel rail pressure sensor 400, a cam position sensor 410, a crank position sensor 420, exhaust pressure and temperature sensors 430, an EGR temperature sensor 440, and an accelerator pedal position sensor 445. Furthermore, the ECU 450 may generate output signals to various control devices that are arranged to control the operation of the ICE 110, including, but not limited to, the fuel unit pump 180, fuel injectors 160, the throttle body 330, the EGR Valve 320, the VGT actuator 290, and the cam phaser 155. Note, dashed lines are used to indicate communication between the ECU 450 and the various sensors and devices, but some are omitted for clarity.

Turning now to the ECU 450, this apparatus may include a digital central processing unit (CPU) in communication with a memory system, or data carrier, and an interface bus. The CPU is configured to execute instructions stored as a program in the memory system, and send and receive signals to/from the interface bus. The memory system may include various storage types including optical storage, magnetic storage, solid state storage, and other non-volatile memory. The interface bus may be configured to send, receive, and modulate analog and/or digital signals to/from the various sensors and control devices.

Instead of an ECU 450, the automotive system 100 may have a different type of processor to provide the electronic logic, e.g. an embedded controller, an onboard computer, or any processing module that might be deployed in the vehicle.

According to an embodiment of the present disclosure, as shown in FIG. 5, a tool 1 for installing a roller tappet 20 in a bore 130a of the cylinder head 130 includes an elongated body 2 and a connection head 3 arranged at one end 2a of the elongated body 2.

According to an embodiment, the elongated body 2 is cylindrical and its section has dimensions suitable for inserting the tool 1 inside the bore 130a. In other words, the dimension of the diameter of the elongated body 20 is smaller than the diameter of the bore 130a. Typically, the diameter of the elongated body 2 is substantially equal to the diameter of the bore 130. In more detail, the diameter of the elongated body 2 is slightly smaller than the diameter of the bore 130a, so as to provide a small clearance between the two elements. Such a small clearance prevents tilting of the elongated body 2 with respect to the axis of the bore 130a, but at the same time allows easy sliding (i.e. with low or substantially absent friction) of the first within the latter.

In a preferred embodiment of the present disclosure, the connection head 3 includes a reduced, i.e. smaller, cross section with respect to the cross section of the elongated cylindrical body 2. In general, the connection head 3 is configured to be at least partially inserted into an opening 20a of the roller tappet 20.

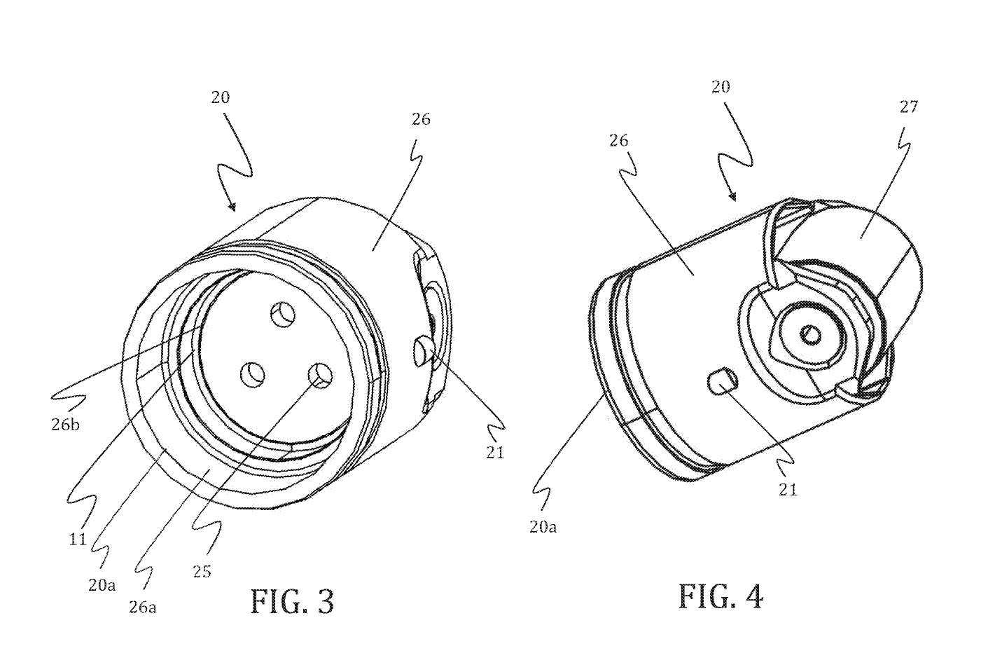

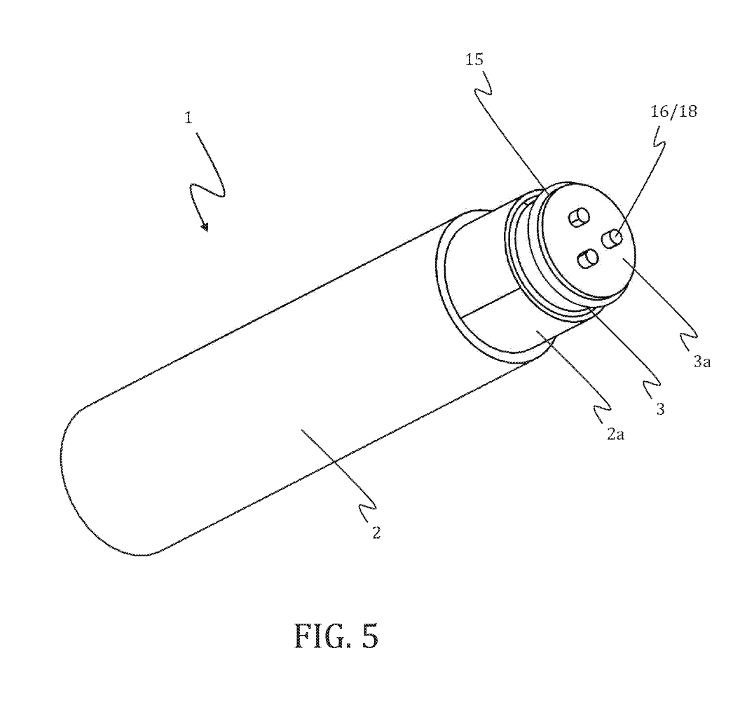

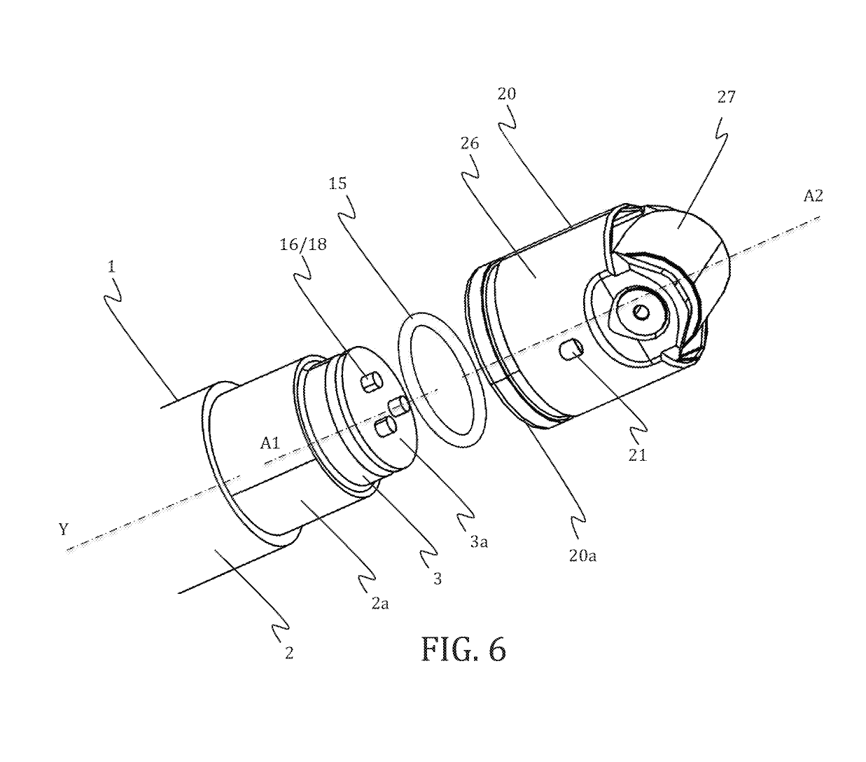

With reference to FIGS. 2-3, the roller tappet 20 typically includes a roller tappet body 26, carrying a roller 27, which is generally at least partially hollow, so as to define an opening 20a at one end of the roller tappet body 26, typically opposite to the roller 27. In particular, as shown in the figures, the roller tappet body 26 generally includes a hollow cylindrical portion 26a, ending with an opening 20a.

The connection head 3 is thus configured (i.e. dimensioned) so as to allow partial insertion of the tool 1 within the roller tappet body 26 through the opening 20a. As a result, the connection head 3 is typically provided with a smaller cross section with respect to the opening 20a.

According to an embodiment, the shape of at least part of the connection head 3 matches the shape of at least a portion of the internal surface 26b of the roller tappet body 26, so that when the connection head 3 is inserted within the roller tappet body 26, tilting between the two elements is substantially avoided, or in any case greatly limited.

As mentioned, the roller tappet body 26 typically is provided with a hollow cylindrical portion 26a. As a result, the connection head is provided with a substantially cylindrical portion 3a. As mentioned, the cylindrical portion 3a of the connection head has a diameter that is substantially equal to the diameter of a section of the internal surface 26b of the roller tappet body 26.

As mentioned, in general the connection head 3 is configured to be inserted within the opening 20a of the roller tappet 26, preferably in a manner to prevent relative tilting between the connection head 3 and the roller tappet 26. In other words, once coupled, the axis A1 of the connection head 3 is typically parallel to (generally coincident with) the axis A2 of the roller tappet body 26, and tilting between the two axis are substantially avoided, or in any case greatly limited.

According to an embodiment, the tool 1 can further include at least one reversible constraining element 15 to the roller tappet 20. The reversible constraining element 15 allows reversible coupling between the tool 1 and the roller tappet 20, typically between the connection head 3 and the roller tappet body 26. Various reversible constraining elements 15 can be used for this purpose. Preferably, the reversible constraining element 15 is configured to realize a snap fit engagement or an interlocking engagement with the roller tappet 20.

According to an embodiment, the reversible constraining element 15 engage an internal groove 11 of the roller tappet 20. In other words, the roller tappet 20 is provided with an internal groove 11, and the shape of the reversible constraining element 15 is configured to match the internal groove 11 of the roller tappet 20.

As mentioned, typically the roller tappet 20 is provided with a cylindrical roller tappet body 26. As a result, the groove 11 is substantially annular and the constraining element 15 includes a substantially annular protruding portion. In the shown embodiment, the annular protruding portion of the reversible constraining element 15 is an O-ring. Once the connection head 3 and the roller tappet 20 are coupled, the O-ring is compressed between the two elements (e.g. against the connection head 3 and the groove 11 of the roller tappet), so as to constrain the one to the other.

In general, the reversible constraining element 15 of the tool 1 prevents the relative sliding movement, and in particular relative translation movement, between the connection head 3 and the roller tappet 20. In this way, the tool 1 can be slid inside the bore 130a of the cylinder head 130 so that undesired decoupling of the roller tappet 20 from the connection head 3 can be prevented. Therefore, separation of the roller tappet 20 and the tool 1 is prevented. In general, the reversible constraining element 15, e.g. the O-ring, are configured in such a way the separation of the tappet roller 20 and the tool 1 can be obtained only if a force (e.g. a separation force acting on the two coupled lent in two substantially opposite directions) above a predetermined value is applied.

According to an embodiment of the present disclosure, as shown in FIGS. 5 and 6, the tool 1 further includes at least one rotation-locking element 16 to prevent the relative rotation movement of the connection head 3 and the roller tappet 20. In other words, the rotation-locking element 16 prevents rotation of the tool 1 with respect to the roller tappet 20 around the axis A1 of the connection head 3. Therefore, the rotation movement applied to the tool 1 is rigidly transferred to the roller tappet 20.

According to an embodiment of the present disclosure, shown in the figures, the rotation-locking element 16 includes at least one protruding element 18, protruding from the connecting head 3. In particular, the protruding element cooperates with a relevant seat 25 (typically a hole) in the roller tappet 20. Various embodiments are possible. In the embodiment shown, the tool 1 includes three protruding elements 18, substantially shaped as pins.

The protruding elements 18, once inserted within the seats 25 (for example, shaped as holes) prevent relative rotation between the tool 1 and the roller tappet 20. Different embodiments can be provided with different kinds and/or a different number of protruding elements. As an example, an embodiment can be provided with a protruding element 18 with a non-circular cross-section. Otherwise, at least one protruding element can be arranged in an offset position with respect to a longitudinal axis Y (which generally coincides with the axis A1 of the connection head 3) of the elongated cylindrical body 2. Such an offset pin can be either provided with a circular or a non-circular cross section.

According to an embodiment, protruding elements 18 are disposed on the tool so as to be at least in part inserted in corresponding pre-arranged seats 25 of the roller tappet 20. In other words, the protruding elements 18 are arranged on the tool 1 so as to take advantage of the shape of the roller tappet 20. As an example, in the shown embodiments the protruding element 18 are arranged on the tool so as to cooperate with venting holes of the roller tappet 20 that, when the tool 1 is coupled to the roller tappet 20, act as the seat 25 for the protruding elements 18.

The hole 25 is an already-existing hole 25 of the roller tappet 20 and preferably a venting hole 25 that after the installation of the roller tappet in the bore of the cylinder head and is constrained to a movable plunger of a fluid unit pump, allows a fluid passage inside the roller tappet during the reciprocating movement inside the bore. Accordingly, the number, the dimensions and the configuration of the protruding elements, e.g. pins 18, are designed to match the already-existing hole 25 of the roller tappet 20. In this way, the roller tappet 20 can be rotated inside the bore 130a of the cylinder head 130 with precision by acting on the axial rotation of the tool 1.

As disclosed in greater detail later with reference to the method of installation of the roller tappet 20 by the tool 1, the rotation-locking element 16, and in particular the cooperation of the at least one protruding element 18 with the relevant seat 25 arranged on the roller tappet allows to prevent rotation of the tool 1 with respect to the roller tappet 20. By doing so, during installation of the roller tappet, the angular position of the roller tappet with respect to the bore can be fine adjusted by rotating the tool 1 to which the roller tappet is constrained.

More in detail, the tool 1 is rotated to align an anti-rotation protrusion 21 of the roller tappet 20, arranged on the external surface of the roller tappet, and in general protruding form an lateral surface of the roller tappet is aligned with a an anti-rotation seat 133 of the bore 130a. The anti-rotation seat 133 is arranged on the internal wall (surface) of the bore in which the roller tappet has to be inserted, and it is configured for example in the form of a groove, and preferably a rectilinear groove, starting in correspondence to an opening of the bore.

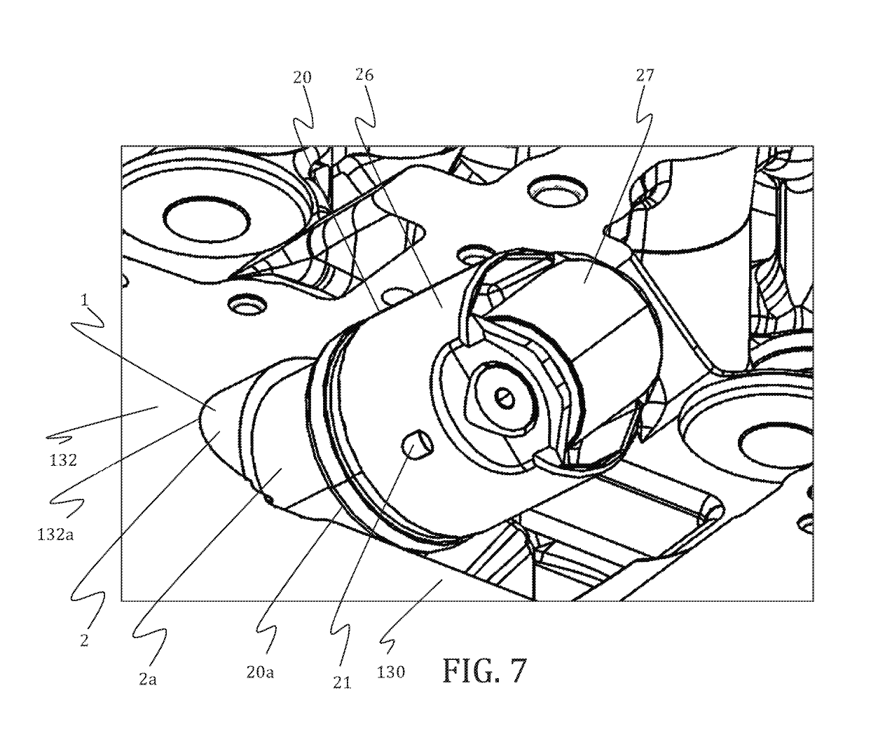

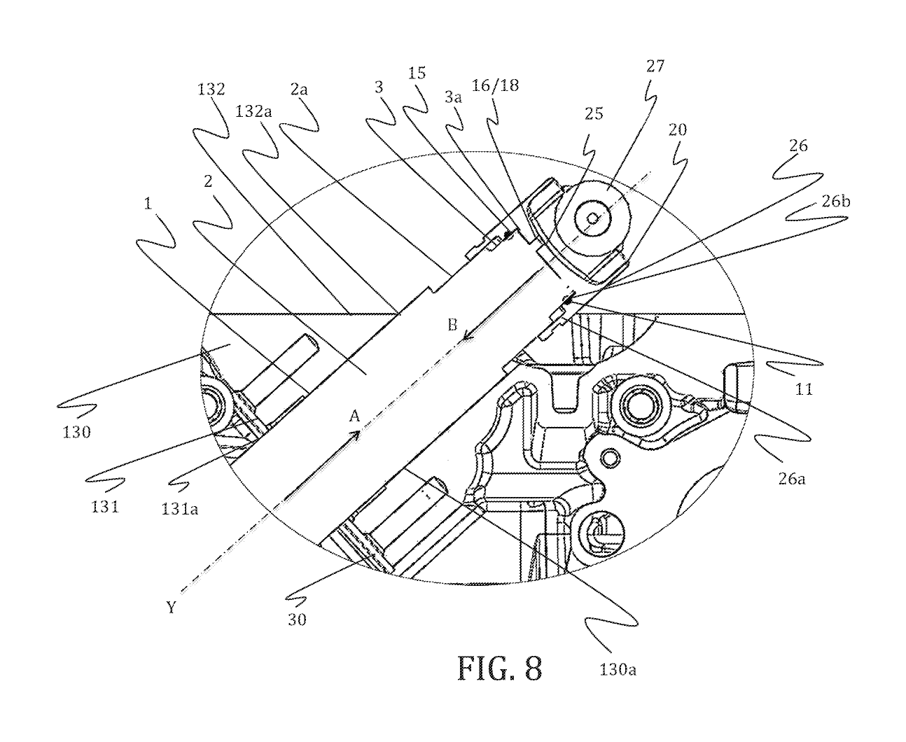

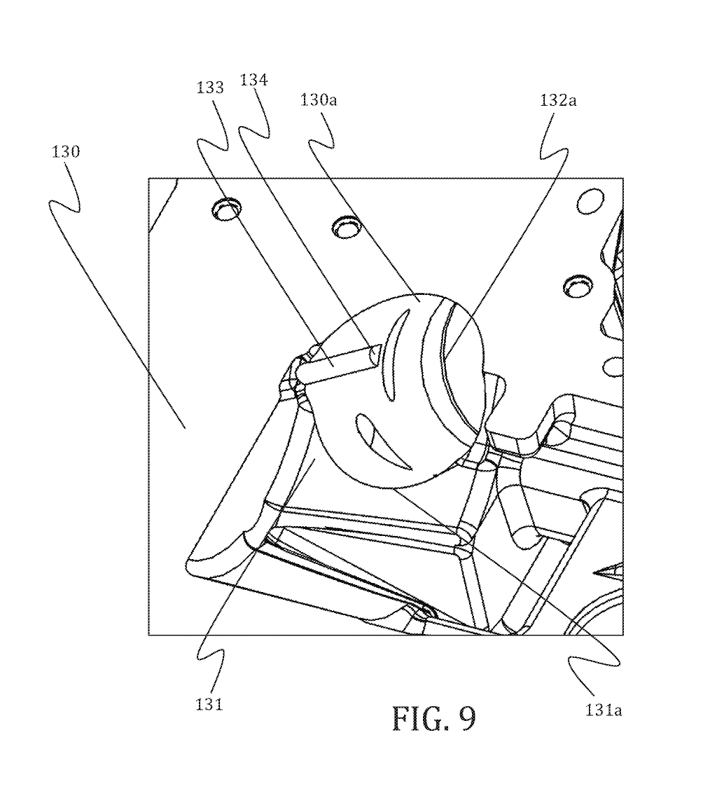

A possible embodiment of the method of installation of a roller tappet 20 in a bore 130a, will be now disclosed with reference to FIGS. 7, 8 and 10 (the latter illustrating a flowchart). It has to be firstly noted that the bore 130a in which the roller tappet 20 has to be installed extends between two substantially opposite sides 131, 132 of the cylinder head 130 of an internal combustion engine 110 and that defines a first opening 131a and second opening 132a.

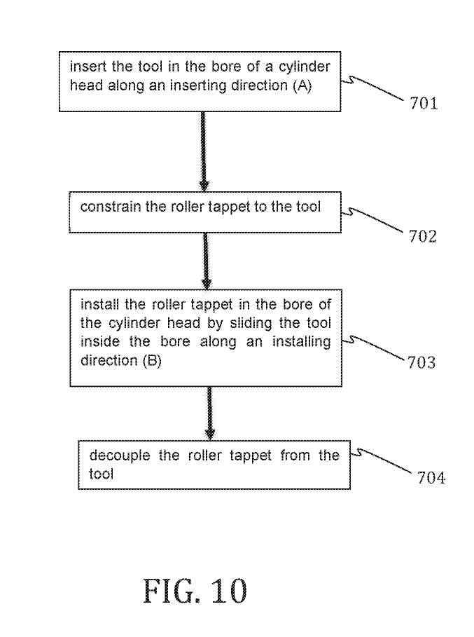

The method of installation is carried out by a tool 1 and includes inserting the tool 1 in the bore 130a along an inserting direction A (see for example block 701 in FIG. 10) and constraining the roller tappet 20 to the tool 1 by inserting the connection head 3 in the opening 20a of the roller tappet 20 (see for example block 702 in FIG. 10).

It has to be noted that these operations are not necessarily carried out in the above reported order. In fact, constraining the roller tappet 20 to the tool 1 can be carried out before of inserting the tool 1 in the bore 130a along an inserting direction A (in other words, according to a possible embodiment the order of blocks 701 and 702 in FIG. 10 can be reversed).

According to a possible embodiment, as for example shown in the FIGS. 7, 8 and 10, inserting the tool 1 in the bore 130a is carried out before constraining the roller tappet 20 to the tool 1. In fact, the roller tappet 20 can be constrained to the tool 1, and in particular to the connection head 3 after the tool has been inserted in the bore 130a.

As it will be disclosed later in greater detail, this order of the above mentioned operations is preferably used when the tool is inserted in the bore 130a from a lower opening (first opening 131a) of the cylinder head, and in general from the side 131 on which a mounting flange 30 for the fuel unit pump is arranged.

The method further includes installing the roller tappet 20 in the bore 130a of the cylinder head 130 by sliding the tool inside the bore 130a along an installing direction B (see for example block 703 in FIG. 10). It has to be noted that the inserting direction A can be opposite with respect to the installing direction B. In particular, the inserting direction A and the installing direction B preferably lie on the same line but have opposite direction. More in particular, the inserting direction A and the installing direction B preferably lie on the longitudinal axis Y of the elongated body when inserted inside the bore 130a.

The method further includes decoupling the roller tappet 20 installed in the bore 130a from the tool 1 (see for example block 704 in FIG. 10). Insertion of the tool 1 can be carried out from the first opening 131a arranged at a lower side 131 of the cylinder head 130 (e.g. substantially facing the engine block 120) towards the second opening 132a. Preferably, the first opening 131a is arranged at a mounting flange 30 for the fuel unit pump 180.

As mentioned above, according to a possible embodiment, when the tool 1 is inserted from the first opening 131a arranged at a mounting flange 30 for the fuel unit pump 180, insertion of the tool 1 in the bore 130a is carried out before constraining the roller tappet 20 to the tool 1. In particular, the tool 1 is inserted in the first opening 131a until at least the connection head 3 protrudes out from the second opening 132a so that, then, the roller tappet 20 can be constrained to the tool 1 by inserting the connection head 3 in the opening 20a of the roller tappet 20, as shown in FIG. 7.

After the roller tappet 20 is constrained to the tool 1, and in particular to the connection head, the tool 1 is moved in the installing direction B, that is opposite to the inserting direction A, and thus to move back the tool towards the first opening 131a. By doing so, the roller tappet 20 is installed in the bore 130a, from the second opening 132a. In fact, the tool 1 is moved back towards the first opening 131a, and the tool 1 is coupled to the roller tappet 20 due to the reversible constraining element 15.

As mentioned above, relative sliding movement and in particular relative translation movement between are avoided by the reversible constraining element, e.g. the O-ring, so that the tool 1 and the tappet roller are not separated during the installation of the roller tappet in the bore due to the sliding movement of the tool. By doing so, the installation of a roller tappet 20 in an internal combustion engine 110 can be carried out in an easy, rapid and accurate way. In fact, the upper side 132 of the cylinder head 130 is typically not a planar surface, i.e. it typically includes a plurality of non-planar surfaces, while lower side 131 of the cylinder head 130 is typically a planar surface. Consequently, the inserting operation is easier and faster if performed from the lower side 131 rather than from the upper side 132.

In particular, the tool 1 can be easily inserted in the bore 130a form the lower side 131, and thus from the first opening 131a, to protrude with the connection head 3 form the second opening in order to receive the roller tappet 20 that is constrained to the connection head 3. By moving back the tool 1 in the installing direction, i.e. back to remove the connection head 3 from the first opening 131a, the roller tappet 20 constrained to the connection head 3 can be guided in an effective way to be inserted in the bore 130a form the second opening 132a, i.e. from the upper side of the cylinder head, even if the surface is not planar. In fact, the installation movement and in particular the translation of the roller tappet 20 inside the bore 130a is effectively guided by the tool 1, to which the roller tappet is constrained.

It has to be also noted that the tool 1 is rotated to orientate the roller tappet 20 during installation of the roller tappet 20 in the bore 130a of the cylinder head 130. In fact, the rotation-locking element 16 of the tool 1 prevents the relative rotation movement of the connection head 3 and the roller tappet 20, and thus the rotation movement applied to the tool 1 is rigidly transferred to the roller tappet 20. More in detail, the tool 1 is rotated to align an anti-rotation protrusion 21 of the roller tappet 20 with an anti-rotation seat 133 of the bore 130a. In this way, the roller tappet 20 can slide inside the bore 130a without relative rotation during the normal operation of the internal combustion engine 110.

Furthermore, the roller tappet 20 preferably reaches a sliding stop 134 during the step of installing the roller tappet 20 in the bore 130a of the cylinder head 130. Preferably, the sliding stop 134 corresponds to the end portion of the anti-rotation seat 133 where the anti-rotation protrusion 21 is inserted.

Advantageously, the anti-rotation seat 133 extends from the second opening 132a and it is preferably rectilinear, for example it can be a groove obtained on the internal wall of the bore 130a. Moreover, in this way, the decoupling of the roller tappet 20 from the tool 1 can be carried out going on pulling the tool after that the anti-rotation protrusion 21 has reached the sliding stop 134, causing decoupling of the constraining element 15 of the connection head 3 from the opening 20a of the roller tappet 20. In fact, when the roller tappet 20 constrained to the tool 1 is installed in the bore 130a and the anti-rotation protrusion 21 reaches the end portion of the anti-rotation seat 133, by moving further the tool 1 in the inserting direction B, e.g. towards the first opening 131a, a separation force is applied to the roller tappet 20 and the tool 1 causing a release the reversible constraining element 15, e.g. the O-ring.

The method of installing a roller tappet according to an embodiment of the present disclosure can be implemented manually or in automatic way, in fact, the tool 1 can be designed to be operated manually by a human operator or to be mounted on an automatic machine, such as a robot.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-15. (canceled)

16. A tool for installing a roller tappet in a bore of the cylinder head of an internal combustion engine comprising an elongated body, a connection head arranged at one end of said elongated body and having at least one reversible constraining element for the roller tappet, wherein the connection head is configured to be at least partially inserted into an opening of the roller tappet and releasably constrained to the roller tappet.

17. The tool according to claim 16, wherein said at least one reversible constraining element is selected from the group consisting of a snap fit element and an interlocking element.

18. The tool according to claim 16, wherein the at least one reversible constraining element comprises an annular protruding portion configured to prevent relative sliding movement of the connection head and the roller tappet.

19. The tool according to claim 18, wherein the annular protruding portion of the reversible constraining element comprises an O-ring.

20. The tool according to claim 16, further comprising at least one rotation-locking element configured to prevent the relative rotation movement of the connection head and the roller tappet (20).

21. The tool according to claim 20, wherein said rotation-locking element comprises at least one protruding element protruding from the connecting head.

22. The tool according to claim 21, wherein said at least one protruding element is arranged in an offset position with respect to a longitudinal axis of the elongated cylindrical body.

23. The tool according to claim 16, wherein the connection head comprises a reduced cross section with respect to the cross section of the elongated cylindrical body.

24. A system comprising a tool according to claim 16 and a roller tappet comprising a roller tappet body carrying a roller, the roller tappet body is at least partially hollow and has an opening, wherein the connection head of the tool being at least partially inserted inside the roller tappet body through said opening.

25. A method for installing a roller tappet in a bore extending between two substantially opposite sides of a cylinder head and defining a first opening and second opening therein, the method comprising:
inserting a tool in the bore along an insertion direction;
constraining the roller tappet to the tool by inserting a connection head in an opening of the roller tappet;
installing the roller tappet in the bore of the cylinder head by sliding the tool inside the bore along an installation direction; and
decoupling the roller tappet from said tool.

26. The method according to claim 25, further comprising inserting the connection head of the tool from the first opening and translating the tool along the insertion direction towards the second opening until at least a portion of the connection head protrudes from the second opening, wherein the roller tappet is constrained to the connection head protruding outside the second opening opposite to the first opening from which the tool is inserted in the bore.

27. The method according to claim 25, wherein said insertion direction is opposite with respect to said installation direction.

28. The method according to claim 25, wherein insertion of the tool is carried out from the first opening, arranged at a lower side of the cylinder head facing the engine block, towards the second opening arranged at the opposite side of the cylinder head.

29. The method according to claim 25, further comprising rotating the tool to orient the roller tappet when installing the roller tappet in the bore of the cylinder head.

30. The method according to claim 29, further comprising rotating the tool to align an anti-rotation protrusion of the roller tappet with an anti-rotation seat of the bore.

31. The method according to claim 25, further comprising installing the roller tappet in the bore of the cylinder head the roller tappet until the roller tappet reaches a sliding stop.
